(19) United States
(12) Patent Application Publication
(10) Pub. No.: US 2010/0042468 A1
(43) Pub. Date: Feb. 18, 2010

(54) AUTOMATIC SURVEY REQUEST BASED ON TICKET ESCALATION

(75) Inventors: Christopher Doan, Austin, TX (US); Praveen Hirsave, Austin, TX (US); Venkatesan Ramamoorthy, Round Rock, TX (US)

Correspondence Address: IBM - SPP;SHIMOKAJI & ASSOCIATES, P.C., 8911 Research Drive, Irvine, CA, 92618, US

(73) Assignee: INTERNATIONAL BUSINESS MACHINES CORPORATION, Armonk, NY (US)

(21) Appl. No.: 12/192,596

(22) Filed: Aug. 15, 2008

(51) Int. Cl. G06Q 10/00

(52) U.S. Cl. 705/10

(57) ABSTRACT

A system and method of processing customer services requests is disclosed. A customer reported problem may generate a customer service request and problem ticket. A technical support team may respond to and resolve the problem. A customized customer satisfaction survey may be generated based on the content of the problem ticket. Customer feedback from the survey and customized surveys may be stored for analysis to retrieve and generate future customized surveys for future service requests.

### BACKGROUND OF THE INVENTION

The present invention generally relates to customer service and more particularly to customized customer satisfaction surveys.

In some business relationships, customer service agreements may be made where a host business provides technical support to a customer. When problems arise that qualify under such customer service agreements, it is known to issue service tickets for each problem the customer wishes resolved. When processing is completed on a ticket or it is closed, some may find it meaningful to inquire from the customer their opinion on how the activities were conducted, thus, providing feedback on the process.

Some methods of gathering customer feedback include automatically sending a customer a general survey regarding their experience. Such surveys may be static and ask several customers the same questions, some of which may not have been applicable to a particular customer's experience. In addition, the same survey may be re-sent to a customer having problems over time, thus having the potential of receiving redundant customer information. Also, some customers may wish to discuss problems specific to their situation yet do not find compatibility in the surveys received to do so.

As can be seen, there is a need for a system and method of generating customized surveys for particular customers.

### SUMMARY OF THE INVENTION

In one aspect of the present invention, a method of processing customer service requests, comprises establishing a customer database of customer accounts including service level agreements associated with specific customers; receiving a customer reported problem; designating the reported problem as a service request; analyzing the service request for a type of service and severity level of the problem; generating a problem ticket based on the service request; attaching the customer's associated service level agreement to the problem ticket; commencing resolution of the reported problem according to the incident/problem ticket; adding relevant configuration item information to the incident/problem ticket during the course of problem resolution; resolving the reported problem; sending the customer a first customized customer satisfaction survey based on the content of the incident/problem ticket including questions pertaining to the service level agreement, severity level, and configuration item information; receiving customer feedback from the first customized customer satisfaction survey; storing the customer feedback and first customized survey in the customer's account to build a database of customer information for analysis in future customer generated service requests; analyzing the customer feedback for patterns of customer dissatisfaction; recommending modifications to a customer's service level agreement according to the analyzed customer feedback; searching stored customer feedback and customized surveys by keyword; sending future service requests stored customized surveys matching reported problems, service level agreements, service types, or severity levels found according to the keyword search; sending future service requests from the customer further customized surveys generated by extracting previously submitted and analyzed information from stored customer feedback; and evaluating the stored customer feedback and stored customized surveys for undesirably high incidences of a service type or consistently unsatisfactory response times to severity levels.

These and other features, aspects and advantages of the present invention will become better understood with reference to the following drawings, description and claims.

### BRIEF DESCRIPTION OF THE DRAWINGS

FIG. 1 depicts a system according to one exemplary embodiment of the present invention; and

FIG. 2 illustrates a series of steps in accordance with an exemplary embodiment of a method of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

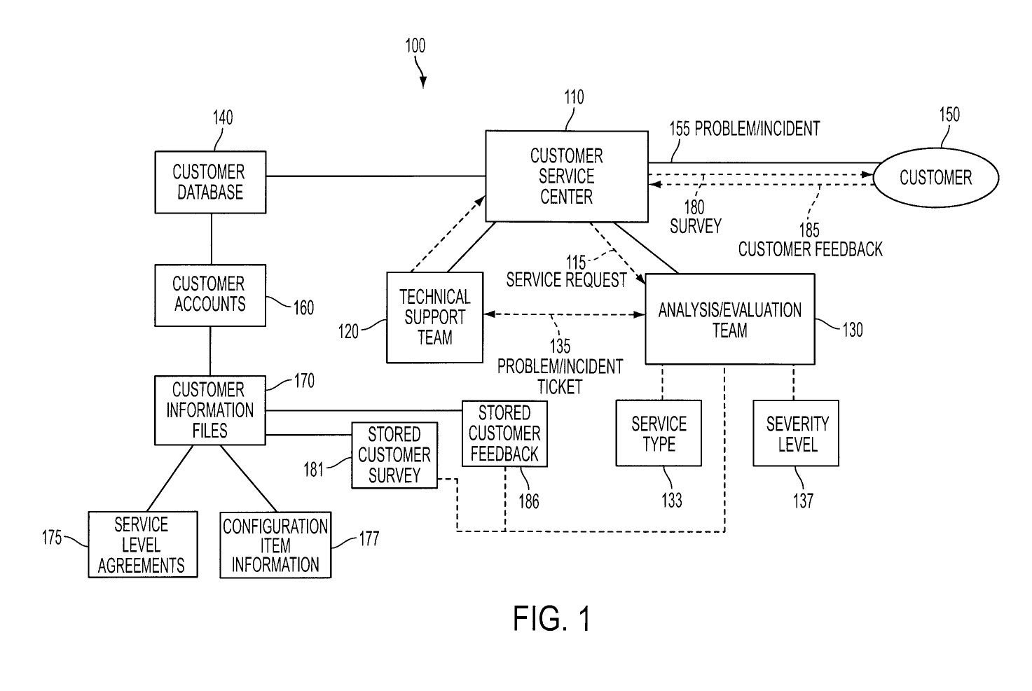

Referring to FIG. 1, an exemplary system 100 for processing customer service is depicted. The system 100 may include a customer 150, a customer service center 110, a technical support team 120, an analysis/evaluation team 130, a customer service database 140, customer accounts 160, and customer information files 170. The customer service center 110 may be a hub for managing the technical support team 120, the analysis/evaluation team 130, and the customer database 140. The customer database 140 may house customer accounts 160 comprising customer information files 170. The customer information files 170 may include, for example, service level agreements 175, configuration item information 177, stored customer surveys 181, and stored customer feedback 186. In one exemplary embodiment, the service level agreement 175 may represent the time expected to respond to and resolve a problem/incident 155 reported by the customer 150. A service request 115 may be generated by the customer service center 110 in response to the problem/incident 155. The analysis/evaluation team 130 may generate a problem/incident ticket 135 in response to the service request 115 which may include a service type 133 and severity level 137. The customer service center 110 may produce and forward surveys 180 to the customer 150 who, in response, may generate a customer feedback 185 stored in the customer information files 170.

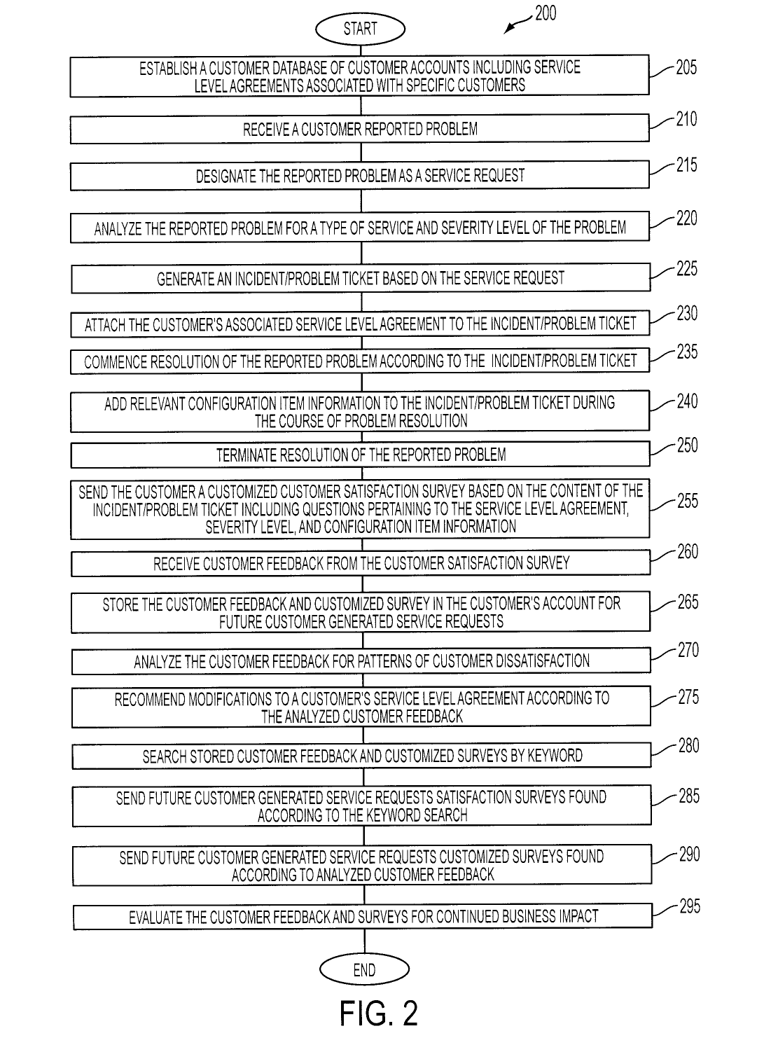

FIG. 2 illustrates a method according to an exemplary embodiment of the present invention. In block 205, the customer database 140 of customer accounts 160 may be established. In block 210, a customer 150 may report a problem 155 to the customer service center 110. In block 215, the customer service center 110 may designate reported problems 155 as needing a service request 115 and forward the service request 115 to the analysis/evaluation team 130. In block 220, the analysis/evaluation team 130 may analyze the service request 115 for a service type 133 needed and a severity level 137 of the problem 155. In block 225, a problem/incident ticket 135 may be generated based on the service request 115 and forwarded to the technical support team 120. In block 230, the customer's associated service level agreement 175 may be attached to the problem/incident ticket 135. In block 235, the technical support team 120 may commence resolution of the reported problem 155 according to the incident/problem ticket 155. In block 240, relevant configuration item information 177 may be added to the incident/problem ticket 155 during the course of resolving the problem or incident 155. In block 245, the technical support team 120 may resolve the reported problem 155. In block 250, the incident/problem ticket 135 may be closed.

Referring again to FIG. 2, the results of a resolved problem 155 may be used to gather further customer information files 170 for analysis. For example, in block 255, the customer 150 may be sent a customized customer satisfaction survey 180 based on the content of the incident/problem ticket 135 including questions pertaining to the service level agreement 175, severity level 137, and configuration item information 177. In block 260, customer feedback 185 may be received from the customer satisfaction survey 180. In block 265, the customer feedback 185 and customized survey 180 may be stored as customer feedback 186 and customer survey 181 in the customer's customer information files 170 for reference in future customer generated service requests 115. In block 270, the stored customer feedback 186 may be analyzed by the analysis/evaluation team 130 for patterns of customer dissatisfaction. In block 275, modifications may be recommended by the analysis/evaluation team 130 to the customer service center 110 to modify a customer's 150 service level agreement 175 according to the analyzed stored customer feedback 186 and stored customer surveys 181. In block 280, stored customer feedback 186 and stored surveys 181 may be searched by keyword. In block 285, future customer generated service requests 115 may be sent surveys 180 found among the stored surveys 181 according to the keyword search. In block 290, future customer generated service requests 115 may be sent customized surveys 180 based on analyzed stored customer feedback 186. In block 295, the stored customer feedback 186 and stored surveys 181 may be evaluated for continued business impact. Thus, the stored customer feedback 186 and stored surveys 181 may be correlated to show, for example, undesirably high incidences of a service type 133 or consistently unsatisfactory response times to severity levels 137 that may be adjusted for future business practices.

It should be understood, of course, that the foregoing relates to exemplary embodiments of the invention and that modifications may be made without departing from the spirit and scope of the invention as set forth in the following claims.

What is claimed is:

1. A method of processing customer service requests, comprising:
establishing a customer database of customer accounts including service level agreements associated with specific customers;
receiving a customer reported problem;
designating the reported problem as a service request;
analyzing the service request for a type of service and severity level of the problem;
generating a problem ticket based on the service request;
attaching the customer's associated service level agreement to the problem ticket;
commencing resolution of the reported problem according to the incident/problem ticket;
adding relevant configuration item information to the incident/problem ticket during the course of problem resolution;
resolving the reported problem;
sending the customer a first customized customer satisfaction survey based on the content of the incident/problem ticket including questions pertaining to the service level agreement, severity level, and configuration item information;
receiving customer feedback from the first customized customer satisfaction survey;
storing the customer feedback and first customized survey in the customer's account to build a database of customer information for analysis in future customer generated service requests;
analyzing the customer feedback for patterns of customer dissatisfaction;
recommending modifications to a customer's service level agreement according to the analyzed customer feedback;
searching stored customer feedback and customized surveys by keyword;
sending future service requests stored customized surveys matching reported problems, service level agreements, service types, or severity levels found according to the keyword search;
sending future service requests from the customer further customized surveys generated by extracting previously submitted and analyzed information from stored customer feedback; and
evaluating the stored customer feedback and stored customized surveys for undesirably high incidences of a service type or consistently unsatisfactory response times to severity levels.
